(19) United States
(12) Patent Application Publication
(10) Pub. No.: US 2011/0254891 A1
(43) Pub. Date: Oct. 20, 2011

(54) Fixing structure for print head carriage rod

(75) Inventor: Chih-Hwa Wang, Taipei (TW)

(73) Assignees: KINPO ELECTRONICS INC., Taipei County (TW); Cal-Comp Electronics & Communications Company Limited, Taipei County (TW)

(21) Appl. No.: 12/801,112

(22) Filed: May 24, 2010

(30) Foreign Application Priority Data
Apr. 20, 2010 (TW) 099112421

(51) Int. Cl. B41J 2/015

(52) U.S. Cl. 347/20

(57) ABSTRACT

A fixing structure for print head carriage rod is disclosed. The fixing structure is simplified and is able to minimize the flexure of the carriage rod, whereby a print head carriage can smoothly travel along the carriage rod. The fixing structure includes a frame body disposed in a printing machine, and a carriage rod mounted on the frame body for the print head carriage to reciprocally travel on the carriage rod for printing operation. The frame body has sidewalls and support sections for supporting the carriage rod in a predetermined position. The fixing structure further includes retainers, which are passed through the sidewalls of the frame body and inserted into fixed ends of the carriage rod in an axial direction thereof so as to secure the carriage rod to the frame body. The retainers and the support sections of the frame body together prevent the carriage rod from being flexed.

### BACKGROUND OF THE INVENTION

1. Field of the Invention

The present invention relates generally to a fixing structure for a carriage rod, and more particularly to a fixing structure for a carriage rod on which an ink cartridge carriage of a printing machine is supported to smoothly reciprocally travel along the carriage rod.

2. Description of the Related Art

It is well known that a paper can be printed with a printing machine such as an inkjet printer. The inkjet printer has an ink cartridge having a print head. The ink cartridge is carried by an ink cartridge carriage to reciprocally move in a direction normal to a paper delivery direction. The ink cartridge carriage is positioned above the surface of a paper that passes through a printing section by a set height, whereby the print head can jet the ink onto the paper to form characters or pictures.

Please refer to FIG. 1. In general, the ink cartridge carriage A is supported on a carriage rod B to reciprocally travel along the carriage rod through a printing section P for printing operation. Two screws C are screwed through two sides of the carriage rod B from a surface thereof to secure the carriage rod B to a frame body E of the printing machine D. The frame body E has two support sect ions F for supporting the carriage rod B and spacing the carriage rod B from the frame body E by a distance.

The above structure has a defect. That is, after the screws C are tightened, the carriage rod B will be flexed and deformed. It is found that before the screws C are tightened to lock the two sides of the carriage rod B to the frame body E, the screws C will not exert a stress onto the carriage rod B. Under such circumstance, the carriage rod B will not be strained. However, when the screws C are tightened with a torque, a screw fasten force is applied to the two sides of the carriage rod B. At this time, a middle section of the carriage rod B will be flexed to change the set height of the ink cartridge carriage A that reciprocally travels along the carriage rod B through the printing section P. This will affect the printing quality. FIGS. 2 to 4 respectively are a force diagram, a shear diagram and a bending moment diagram of a conventional carriage rod B, which is tightened to the frame body E by means of the screws C and the cooperative support sections F of the frame body E. FIG. 4 shows that the flexed section of the carriage rod B is right above the printing section P.

Referring to FIGS. 5 and 6, in another conventional fixing structure for the carriage rod, the frame body E is formed with slots E2 and provided with slightly resilient cantilevers E3 between the slots E2. When the two sides of the carriage rod B are respectively locked to the cantilevers E3 of the frame body E by means of the screws C, the cantilevers E3 are able to partially absorb the deformation of the carriage rod B caused by the torque of the screws C. However, with the slots E2 and the cantilevers E3, the structural strength of the frame body E is weakened. As a result, the carriage rod B tends to vibrate when the ink cartridge carriage A reciprocally travels along the carriage rod B in printing operation. Moreover, in some cases, for example, during transfer, delivery or maintenance of the printing machine, the carriage rod B is likely to be displaced or damaged due to collision caused by negligence.

To overcome the above problems, in another conventional fixing structure for the carriage rod, two ends of the carriage rod are directly secured to the frame body by means of retainers such as rivets, screws or the like. The sidewalls of the frame body support the carriage rod in cooperation with the retainers. This can facilitate assembling process of the printing machine and lower the manufacturing cost thereof. However, in such structure, the carriage rod is still subject to flexion due to the bending moment.

### SUMMARY OF THE INVENTION

It is therefore a primary object of the present invention to provide a fixing structure for print head carriage rod. The fixing structure is simplified and is able to minimize the flexure of the carriage rod, whereby the ink cartridge carriage of a printing machine can smoothly reciprocally travel along the carriage rod. The fixing structure includes a frame body disposed in the printing machine, and a carriage rod mounted on the frame body for the ink cartridge carriage to reciprocally travel on the carriage rod for printing operation. The frame body has sidewalls and support sections for supporting the carriage rod in a predetermined position. The fixing structure further includes retainers. The retainers are passed through the sidewalls of the frame body and inserted into fixed ends of the carriage rod in an axial direction thereof so as to secure the carriage rod to the frame body. The retainers and the support sections of the frame body together prevent the carriage rod from being flexed in a direction normal to the axial direction. Therefore, the deterioration of printing quality can be avoided.

The present invention can be best understood through the following description and accompanying drawings, wherein:

### BRIEF DESCRIPTION OF THE DRAWINGS

FIG. 1 is a front view a conventional printing machine, showing that screws are screwed through two sides of the carriage rod to lock the carriage rod to the frame body;

FIG. 2 is a force diagram of a conventional carriage rod, which is tightened to the frame body by means of screws and cooperative support sections of the frame body according to FIG. 1;

FIG. 3 is a shear diagram of the conventional carriage rod, which is tightened to the frame body by means of screws and cooperative support sections of the frame body according to FIG. 1;

FIG. 4 is a bending moment diagram of the conventional carriage rod, which is tightened to the frame body by means of screws and cooperative support sections of the frame body according to FIG. 1, showing that the flexed section of the carriage rod is right above the printing section;

FIG. 5 shows that the frame body is formed with slots and provided with cantilevers between the slots;

FIG. 6 is a view according to FIG. 5, showing that the carriage rod is locked to the cantilever of the frame body by means of a screw;

FIG. 7 is a plane view of a preferred embodiment of the present invention, showing that the retainers are passed through the sidewalls of the frame body and inserted into fixed ends of the carriage rod in an axial direction thereof to secure the carriage rod to the frame body;

FIG. 8 is a sectional view of a part of FIG. 7, showing that the carriage rod is spaced from the frame body by a distance; and

FIG. 9 is a perspective view of the preferred embodiment of the present invention, showing that the retainers are passed through the sidewalls of the frame body and inserted into fixed ends of the carriage rod in an axial direction thereof to secure the carriage rod to the frame body.

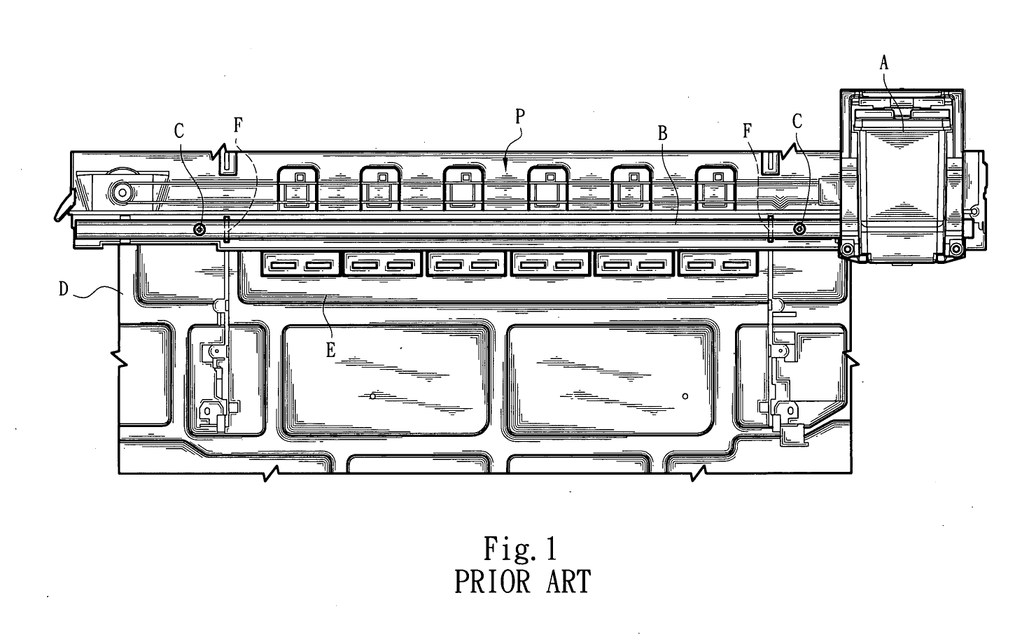

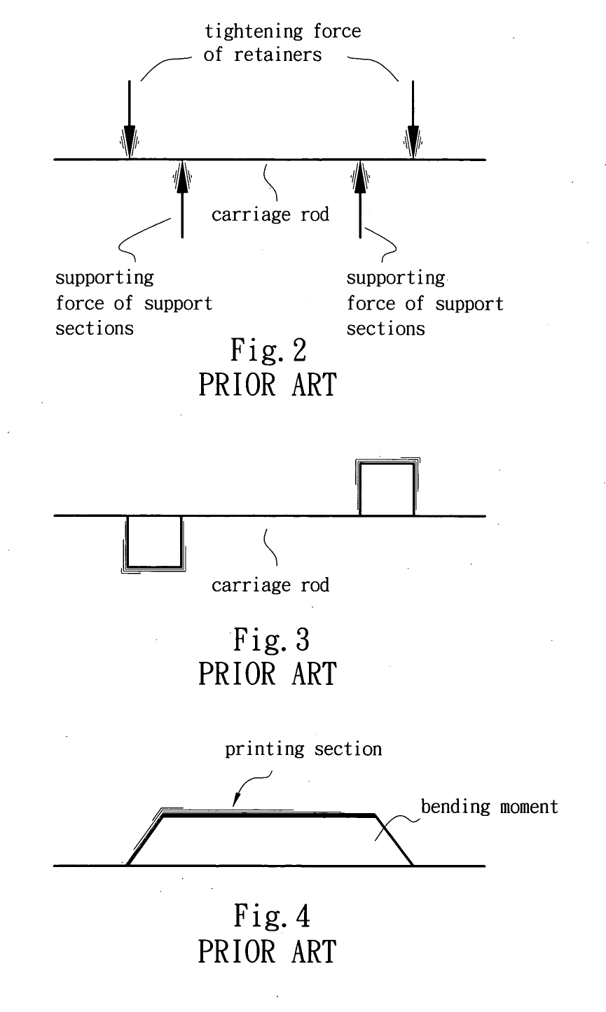

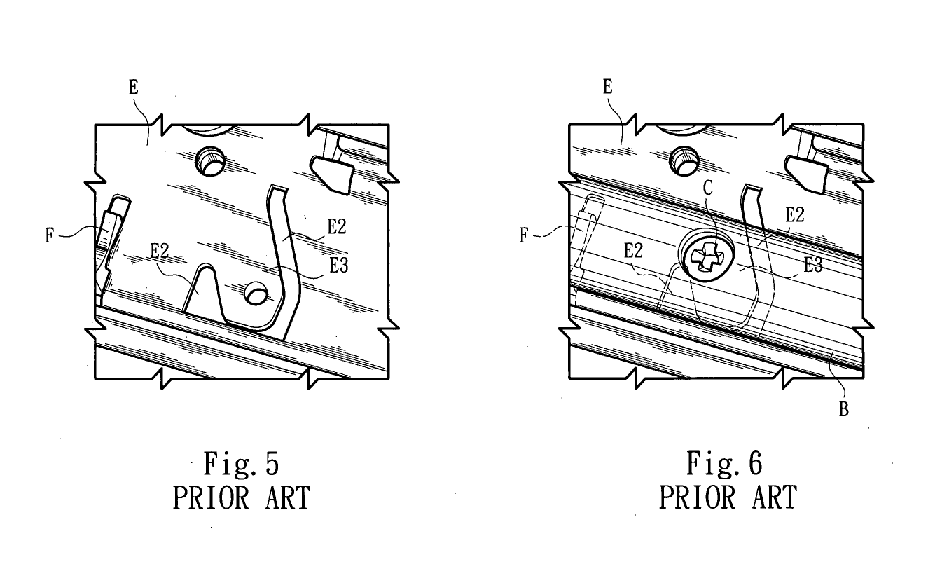

### DETAILED DESCRIPTION OF THE PREFERRED EMBODIMENTS

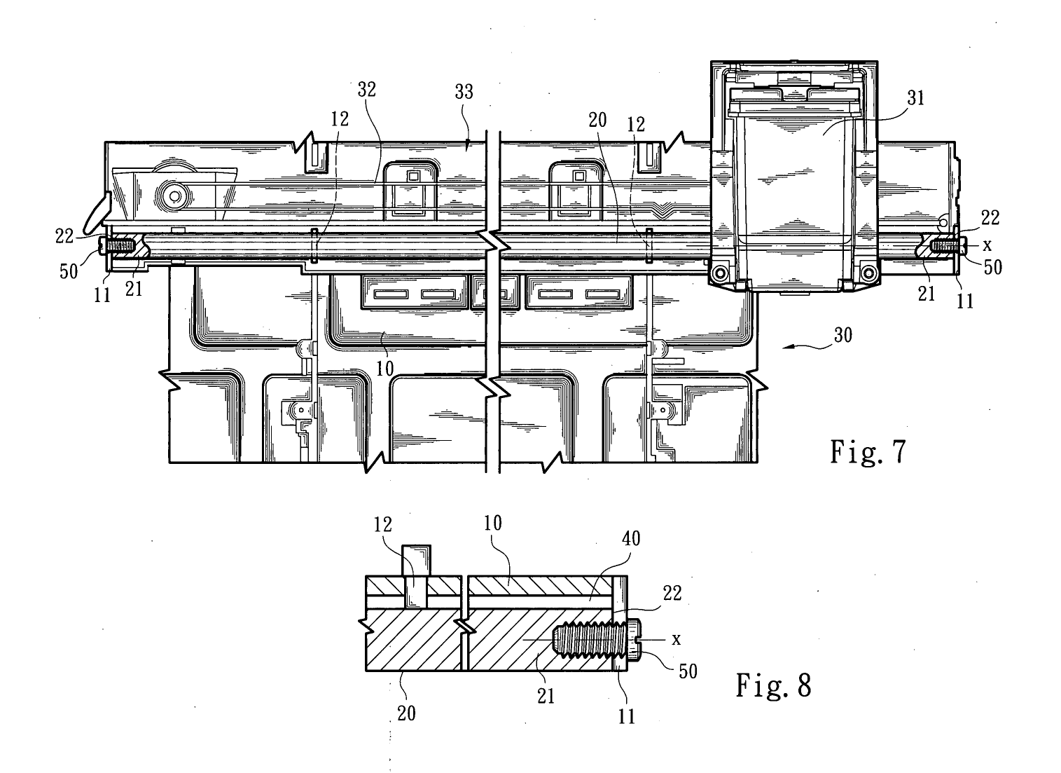

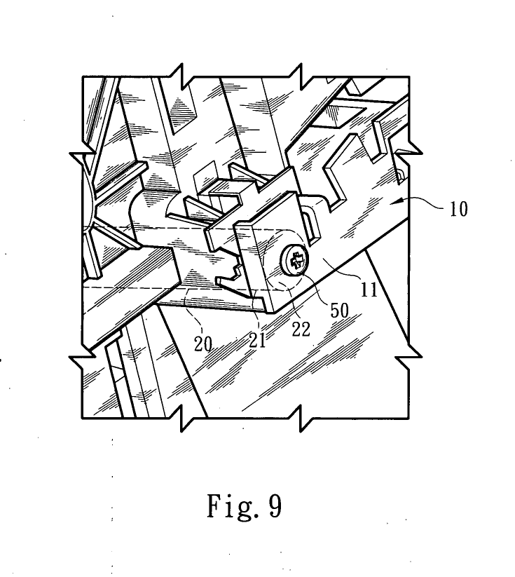

Please refer to FIGS. 7, 8 and 9. The fixing structure for print head carriage rod of the present invention includes a frame body 10 and a carriage rod 20 assembled therewith. The frame body 10 is disposed in a printing machine 30. According to a preferred embodiment of the present invention, an inkjet printer is taken as an example of the printing machine 30, which has a print head and an ink cartridge carriage 31. In this embodiment, the frame body 10 has sidewalls 11 and support sections 12 for supporting the carriage rod 20 in a predetermined position and spacing the carriage rod 20 from the frame body 10 by a distance 40. Accordingly, the carriage rod 20 is spaced from the platen (not shown) arranged on the frame body 10 of the printing machine 30 by a fixed distance or height. The print head and the ink cartridge carriage 31 are supported on the carriage rod 20. The ink cartridge carriage 31 can be driven via a belt 32 to reciprocally travel along the carriage rod 20 to execute printing operation on a printing section 32.

Referring to FIGS. 7, 8 and 9, the carriage rod 20 has two fixed ends 21 each having a plane face 22 formed on the fixed end 21. The plane face 22 is normal to an axis x of the carriage rod 20. In a preferred embodiment, a retainer 50 is disposed at each fixed end 21 of the carriage rod 20 in the direction of the axis x of the carriage rod 20 for securing the fixed end 21 to the sidewall 11 of the frame body. To speak more specifically, the retainer is passed through the sidewall 11 of the frame body and perpendicularly inserted into the fixed end 21 of the carriage rod 20 from the plane face 22 in the axial direction of the carriage rod 20 to secure the carriage rod 20 to the sidewall 21 of the frame body. The retainer 50 can be a rivet, a screw or the like.

It should be noted that when tightened, the retainers 50 apply an action force to the carriage rod 20 in the axial direction thereof to secure the carriage rod 20 to the sidewalls 11 of the frame body. In this case, the carriage rod 20 is free from the shear of FIG. 3 or the bending moment of FIG. 4. That is, the retainers 50 are inserted or screwed into the fixed ends 21 of the carriage rod 20 in a direction of the axis x of the carriage rod 20 or in a direction normal to the plane faces 22 instead of directly screwed into two sides of the carriage rod from the surface thereof. Under such circumstance, the flexure of the section of the carriage rod 20 on the printing section 33 can be minimized. Therefore, the ink cartridge carriage 31 can smoothly reciprocally travel along the carriage rod 20 to ensure a good printing quality.

According to the above arrangement, the fixing structure for the print head carriage rod of the present invention has the following advantages:
1. In comparison with the conventional fixing structure, the retainers 50, the carriage rod 20 and the support sections 12 of the frame body are specifically structurally designed and deployed to minimize the possible flexure of the section of the carriage rod 20 on the printing section 33.
2. According to the arrangement of the retainers 50, the carriage rod 20 and the sidewalls 11 of the frame body of the present invention, it is unnecessary to form any slot nor provide any cantilever structure on the frame body. In this case, the structural strength of the frame body for fixing the carriage rod 20 will not be affected. Also, the vibration of the carriage rod 20 caused by reciprocal travel of the ink cartridge carriage along the carriage rod 20 in printing operation can be minimized. Moreover, the carriage rod 20 is prevented from being displaced or damaged due to collision caused by negligence during transfer, delivery or maintenance.

The above embodiments are only used to illustrate the present invention, not intended to limit the scope thereof. Many modifications of the above embodiments can be made without departing from the spirit of the present invention.

What is claimed is:

1. A fixing structure for print head carriage rod, comprising a frame body and a carriage rod assembled therewith, the frame body being disposed in a printing machine having a printing section, the frame body having at least one sidewall, the carriage rod having an axis and two fixed ends, each of the fixed ends having a plane face formed on the fixed end, the fixing structure further comprising a retainer disposed at each of the fixed ends of the carriage rod in a direction of the axis of the carriage rod for securing the fixed end to the sidewall of the frame body.

2. The fixing structure for print head carriage rod as claimed in claim 1, wherein the retainer is passed through the sidewall of the frame body and perpendicularly inserted into the fixed end of the carriage rod from the plane face in the direction of the axis of the carriage rod to secure the carriage rod to the sidewall of the frame body.

3. The fixing structure for print head carriage rod as claimed in claim 1, wherein the axis of the carriage rod is normal to the plane face.

4. The fixing structure for print head carriage rod as claimed in claim 1, wherein the frame body has at least one support section for supporting the carriage rod and spacing the carriage rod from the frame body by a distance.

5. The fixing structure for print head carriage rod as claimed in claim 1, wherein a print head and an ink cartridge carriage are supported on the carriage rod to reciprocally travel along the carriage rod.

6. The fixing structure for print head carriage rod as claimed in claim 1, wherein the retainer is a rivet.

7. The fixing structure for print head carriage rod as claimed in claim 1, wherein the retainer is a screw.
